(19) United States
(12) Patent Application Publication
(10) Pub. No.: US 2026/0002360 A1
(43) Pub. Date: Jan. 1, 2026

(54) Acoustic Baffle

(71) Applicant: Rockwool A/S, Hedehusene (DK)

(72) Inventors: Jesper Wolff, Hedehusene (DK); Maciej Grzegorz Mosiadz, Zielona Góra (PL)

(21) Appl. No.: 18/880,637

(22) PCT Filed: Jul. 5, 2023
(86) PCT No.: PCT/EP2023/068632

§ 371 Date: Jan. 2, 2025

(30) Foreign Application Priority Data
Jul. 5, 2022 (EP) 22183155.5

(51) Int. Cl. E04B 9/04; E04B 9/00; E04B 9/36; G10K 11/162

(52) U.S. Cl. CPC E04B 9/0435; E04B 9/006; E04B 9/366; G10K 11/162

(57) ABSTRACT

An acoustic baffle comprising: an acoustic panel comprising two opposed major faces and a plurality of minor faces that extend between the two major faces, wherein the acoustic panel is a man-made vitreous fibre (MMVF) panel; a spacer element fixed to a first minor face of the acoustic panel, wherein the spacer element comprises a ferromagnetic material; and at least one magnet fixed to a second minor face of the acoustic panel.

### FIELD OF THE INVENTION

The invention relates to an acoustic baffle, an acoustic baffle system, a method of installing an acoustic baffle system, and a kit for installing an acoustic baffle system.

### BACKGROUND

Acoustic baffles are known in the art and are typically provided in the form of acoustic panels that are suspended from a ceiling using suspension cables, for example as disclosed in EP3404322A1.

The suspension cables are typically attached to the top of the panels. However, acoustic panels suspended in this manner have a tendency to swing about and move in a horizontal plane. As a result, acoustic panels are typically suspended using two suspension cables, one at each end of the acoustic panel. However, this increases the cost of the acoustic baffles and the time taken to install them. Furthermore, acoustic panels suspended with two suspension cables may still move in a horizontal plane.

It may be desirable, either for aesthetic or acoustic purposes, to connect acoustic baffles together.

It is known to connect acoustic panels together using magnets, for example as disclosed in EP3404322A1 and EP2990559A2. However, prior art systems are typically complex and heavy, therefore increasing the materials and cost required to manufacture them. Furthermore, heavy acoustic baffles are more difficult to suspend from a ceiling and pose a safety risk if they were to fall. Known systems also do not allow the relative positions of the acoustic baffles to be easily adjusted during installation or maintenance to ensure accurate alignment. Furthermore, the acoustic baffles cannot be easily disconnected and reconnected if required.

It is desirable to make acoustic panels from a material with good acoustic absorption properties, such as man-made vitreous fibre (MMVF), for example as disclosed in EP0539290 and U.S. Pat. No. 11,293,608. However, MMVF does not necessarily have a high level of mechanical integrity. This is a concern when acoustic panels are suspended from above because the loads from the panel weight are transmitted to the suspension means via the material of the acoustic panel itself. i.e. load paths arising from the panel weight pass through the acoustic panel material. Suspending MMVF acoustic panels from above can therefore compromise the stability of the suspended acoustic panels, particularly for heavier acoustic panels. This may limit the size or density of the acoustic panels that can be used. Since acoustic baffles are suspended overhead, they present a hazard if they were to fall, for example in a fire or earthquake.

Furthermore, it may be desirable to attach additional elements to the acoustic baffles, such as light fixtures. For example, U.S. Pat. No. 11,293,608 discloses acoustic baffles suspended from a ceiling with light modules attached to the underside of the acoustic panels. However, this further increases the load passing through the material of the acoustic panel (e.g. MMVF), thereby decreasing the stability and safety of the acoustic baffles.

### SUMMARY OF INVENTION

In a first aspect of the invention, there is provided an acoustic baffle comprising: an acoustic panel comprising two opposed major faces and a plurality of minor faces that extend between the two major faces, wherein the acoustic panel is a man-made vitreous fibre (MMVF) panel; a spacer element fixed to a first minor face of the acoustic panel, wherein the spacer element comprises a ferromagnetic material; and at least one magnet fixed to a second minor face of the acoustic panel.

The invention provides acoustic baffles that can be easily connected together by bringing the at least one magnet of one acoustic baffle into contact with the spacer element of another acoustic baffle. The spacer element comprises a ferromagnetic material and is thus attracted to the at least one magnet. This magnetic attraction holds the two acoustic baffles together.

The inventors have found that the magnetic connection between the acoustic baffles provides stability against movement of the baffles in a horizontal plane, even when only a single suspension cable is used per baffle.

The acoustic baffles of the invention require very few components in order to be connected together. The acoustic baffles can therefore be made lightweight, making installation easier.

Furthermore, the position of the at least one magnet relative to the spacer element can be easily adjusted to accurately align the baffles, for example during installation and maintenance.

In a second aspect of the invention, there is provided an acoustic baffle system comprising: a first acoustic panel and a second acoustic panel, wherein each acoustic panel comprises two opposed major faces and one or more minor faces that extend between the two major faces, wherein each acoustic panel is a man-made vitreous fibre (MMVF) panel, and wherein each acoustic panel is suspended from a ceiling; a spacer element fixed to a minor face of the first acoustic panel, wherein the spacer element comprises a ferromagnetic material; and at least one magnet fixed to a minor face of the second acoustic panel; wherein a surface of the at least one magnet is in contact with a surface of the spacer element, thereby connecting the first and second acoustic panels together.

In a third aspect of the invention, there is provided a method of installing an acoustic baffle system, the method comprising:
(i) providing a first acoustic panel and a second acoustic panel, wherein each acoustic panel comprises two opposed major faces and one or more minor faces that extend between the two major faces, and wherein each acoustic panel is a man-made vitreous fibre (MMVF) panel;
(ii) fixing a spacer element to a minor face of the first acoustic panel, wherein the spacer element comprises a ferromagnetic material;
(iii) fixing at least one magnet to a minor face of the second acoustic panel;
(iv) suspending the first and second acoustic panels from a ceiling; and
(v) bringing a surface of the at least one magnet into contact with a surface of the spacer element to connect the first and second acoustic panels together.

In a fourth aspect of the invention, there is provided a kit for installing an acoustic baffle system, the kit comprising: a first acoustic panel and a second acoustic panel, wherein each acoustic panel comprises two opposed major faces and one or more minor faces that extend between the two major faces, and wherein each acoustic panel is a man-made vitreous fibre (MMVF) panel; a spacer element configured to be attached to a minor face of the first acoustic panel, wherein the spacer element comprises a ferromagnetic material; at least one magnet configured to be attached to a minor face of the second acoustic panel; and one or more suspension elements for suspending the acoustic panels from a ceiling.

In a fifth aspect of the invention, there is provided an acoustic baffle system comprising: an acoustic panel comprising two opposed major faces and a plurality of minor faces that extend between the two major faces, wherein the acoustic panel is suspended from a ceiling by a suspension element; and a support element extending through the acoustic panel between an upper minor face and a lower minor face of the acoustic panel, wherein an upper end of the support element is attached to the suspension element and a lower end of the support element is attached to a frame element on the lower minor face of the acoustic panel.

The suspension element and the support element support the weight of the acoustic panel from below via the frame element. The load path therefore bypasses the material of the acoustic panel, which increases the overall stability of the suspended acoustic baffle system, and allows the use of larger, heavier acoustic panels. Furthermore, the frame element provides a point of attachment for additional elements (e.g. one or more lights) to be connected. The weight of these additional elements is primarily supported by the suspension element and the support element, rather than the acoustic panel itself, which avoids comprising the stability and safety of the acoustic baffle system.

The same effect can be achieved by directly connecting the suspension element to the frame element.

In a sixth aspect of the invention, there is therefore provided an acoustic baffle system comprising: an acoustic panel comprising two opposed major faces and a plurality of minor faces that extend between the two major faces, wherein the acoustic panel is suspended from a ceiling by a suspension element, wherein the suspension element extends through an upper minor face of the acoustic panel to a lower minor face of the acoustic panel, and wherein the suspension element is attached to a frame element on the lower minor face of the acoustic panel.

### Acoustic Baffle

The acoustic baffle of the invention comprises an acoustic panel. As used herein, the term “acoustic panel” refers to a panel made from materials that absorb sound, i.e. acoustic insulation materials. Any suitable acoustic panel may be used, such as man-made vitreous fibre (MMVF) panels, foam panels, and wood wool cement panels.

It is preferable that the acoustic panels are MMVF panels. MMVF panels have a very high porosity and an open surface, which provides the panel with good acoustic absorption properties.

The MMVF panel may comprise a bonded, nonwoven three-dimensional network of MMVF. The MMVF can for example be stone fibres, glass fibres, slag fibres or ceramic fibres.

Preferably, the MMVF are stone fibres.

Stone fibres may have the following composition, all amounts quoted as wt. % as oxides and all iron oxides being quoted as Fe₂O₃:

| | |
|---|---|
| SiO₂ | 25 to 50, preferably 38 to 48 |
| Al₂O₃ | 12 to 30, preferably 15 to 28 |
| TiO₂ | up to 2 |
| Fe₂O₃ | 2 to 12 |
| CaO | 5 to 30, preferably 5 to 18 |
| MgO | up to 15, preferably 4 to 10 |
| Na₂O | up to 15 |
| K₂O | up to 15 |
| P₂O₅ | up to 3 |
| MnO | up to 3 |
| B₂O₃ | up to 3 |

An alternative stone fibre composition may be as follows, all amounts quoted as wt. % of oxides, and all iron oxides being quoted as Fe₂O₃:

| | |
|---|---|
| SiO₂ | 37 to 42 |
| Al₂O₃ | 18 to 23 |
| CaO + MgO | 34 to 39 |
| Fe₂O₃ | up to 1 |
| Na₂O + K₂O | up to 3 |

The MMVF nonwoven three-dimensional network of the MMVF panel may be bonded using any suitable binder. Suitable binders include phenolic, epoxy, acrylic, water glass, polypropylene, polyethylene, and bicomponent binders.

MMVF panels suitable for use in the invention may have a density of from 50 to 180 kg/m³. Preferably, the MMVF panel has a density of 90 kg/m³ or more, most preferably from 120 to 150 kg/m³. If the density is too low, it may be difficult to manufacture the panel with a precise shape and/or securely attach a suspension cable to the panel. If the density is too high, it may be difficult to suspend the panel from a ceiling due to the increased weight of the panel.

Wood wool cement panels are also suitable for use as the acoustic panel in the invention. A wood wool cement panel may comprise strands of wood-the “wood wool” component is sometimes referred to as “excelsior”-that are bonded with cement. Wood strands may have the form of a tape, with a tape width of from 0.5 to 3 mm.

The wood wool cement panel may consist entirely of wood wool and cement. Alternatively, the wood wool cement panel may be a “sandwich panel”, comprising two wood wool cement boards separated by a core material such as expanded polystyrene, MMVF, or other insulating materials.

It may be desirable for the acoustic panel to be particularly reflective to light in order to improve the distribution of light in the room in which the acoustic baffle is suspended in use. In which case, at least a portion of the acoustic panel may be made from a reflective material or the panel may be coated with a reflective material, such as a reflective paint.

The acoustic panel used in the acoustic baffle of the invention comprises two opposed major faces and a plurality of minor faces that extend between the two major faces.

As will be discussed in more detail below, in the first aspect of the invention a spacer element is fixed to a first minor face of the acoustic panel and at least one magnet is fixed to a second minor face of the acoustic panel. The spacer element comprises a ferromagnetic material and is therefore attracted to magnets. This allows the acoustic baffles of the invention to be connected together by bringing the at least one magnet of one baffle into contact with the spacer element of another baffle. The magnetic attraction between the at least one magnet and the spacer element holds the two acoustic baffles together.

As will be appreciated by the skilled person, any number of acoustic baffles can be connected together in this manner. For example, the at least one magnet of a first baffle may be brought into contact with the spacer element of a second baffle, thereby connecting the first and second baffles together. The at least one magnet of the second baffle may then be brought into contact with the spacer element of a third baffle, thereby connecting the second and third baffles together. This process can be repeated to connect any number of baffles.

It is preferred that the second minor face of the acoustic panel is opposite to the first minor face, because this allows the acoustic baffles to be connected together in a row. In which case, it is further preferred that the at least one magnet is fixed to the second minor face such that it is opposite to the spacer element that is fixed to the first minor face. This is advantageous because the spacer element and the at least one magnet can be fixed in the same position on the acoustic panel in each baffle, while still allowing the baffles to be aligned when they are connected together. This simplifies manufacturing, because all the acoustic baffles can be made identical. If the at least one magnet is not fixed opposite to the spacer element, the positions of the spacer element and magnets on the acoustic panel may need to be different in different baffles in order for the baffles to be aligned when they are connected together.

However, the first and second minor faces, and the spacer element and the at least one magnet fixed to said faces, can be positioned anywhere relative to each other to achieve any desired arrangement of the acoustic baffles.

The acoustic panel may further comprise a third minor face, which preferably extends between opposed first and second minor faces. A frame element may be attached to the third minor face of the acoustic panel, wherein the frame element extends along at least a portion of the length of the third minor face. As will be discussed in more detail below, the frame element may aid alignment of the acoustic baffles. Furthermore, one or more lights may be attached to the frame element to provide lighting in the room in which the acoustic baffles are suspended in use.

The acoustic panel may further comprise a fourth minor face, which preferably extends between opposed first and second minor faces and is preferably opposite to the third minor face.

As will be discussed in more detail below, one or more suspension cables are preferably attached to the acoustic panel so that the acoustic baffle can be suspended from a ceiling in use. Preferably, the acoustic baffle is suspended by one or more suspension cables attached to the fourth minor face of the acoustic panel. In which case, the fourth minor face is, in the suspended configuration, an upper minor face of the acoustic panel, and the two major faces extend downwardly. They will normally in this case be suspended such that the major faces extend substantially vertically. Preferably, the first minor face is on a first side of the acoustic panel and the opposed second minor face is on a second side of the acoustic panel. This allows the acoustic baffles to be connected together in a row, the row extending in a direction substantially parallel to the ceiling. Preferably, the third minor face is a lower minor face. This is advantageous because one or more lights can be attached to the third minor face via the frame element such that light is directed downwards into the room.

The acoustic panel used in the acoustic baffle of the invention may have any shape, but it preferably has the form of a conventional panel. In other words, the two major faces of the acoustic panel are preferably substantially planar and parallel. Similarly, the minor faces of the acoustic panel are preferably substantially planar. Furthermore, the two major faces of the acoustic panel are preferably substantially rectangular. The minor faces preferably extend substantially perpendicular to the two major faces.

The lengths of the first and second minor faces are preferably less than the lengths of the third and fourth minor faces. The length of a minor face is defined as the distance that the minor face extends between the two adjacent minor faces. For example, the length of the third minor face may be the distance that the third minor face extends between the first and second minor faces.

The acoustic panel used in the acoustic baffle of the invention may have any suitable length, such as from 600 to 2400 mm, preferably from 1000 to 2000 mm, more preferably from 1500 to 1700 mm. The length of the acoustic panel is preferably defined as the average distance between the two opposed minor faces that are furthest apart, measured perpendicular to those minor faces.

The acoustic panel may have any suitable width, such as from 100 to 600 mm, preferably from 200 to 500 mm, more preferably from 300 to 400 mm. The width of the acoustic panel is preferably defined as the average distance between the two opposed minor faces that are closest together, measured perpendicular to those minor faces.

The acoustic panel used in the invention may have any suitable thickness, such as from 10-100 mm, preferably from 30 to 70 mm, more preferably 40 to 60 mm. The thickness of the panel is defined as the average distance between the two major faces, measured perpendicular to the major faces.

### Spacer Element

The spacer element is fixed to the first minor face of the acoustic panel.

As discussed above, the spacer element comprises a ferromagnetic material, such that the spacer element is attracted to the at least one magnet fixed to the acoustic panel of another acoustic baffle. The spacer element is preferably made from a ferromagnetic metal, such as galvanized steel. However, the spacer element can be made from any suitable materials, as long as it contains sufficient ferromagnetic material such that the magnetic attraction between the spacer element and the magnets is strong enough to hold the acoustic baffles together. For example, the spacer element may be made from plastic with pieces of ferromagnetic material attached thereto.

The spacer element comprises a surface configured for contacting the at least one magnet of another acoustic baffle. The surface is preferably substantially flat to provide optimal surface contact with the one or more magnets. In a particularly preferred aspect of the invention, the spacer element is formed from a substantially flat plate. In which case, one flat surface of the plate is in contact with the first minor face of the acoustic panel and the opposed flat surface of the plate contacts the one or more magnets of another acoustic baffle in use. The flat surfaces of the plate referred to above are of course major faces of the substantially flat plate. There may be other elements of the spacer, such as an additional ridge, but any such additional elements will not be configured such as to interfere with the contact between the one flat surface and the magnet and the other flat surface and the minor face. The use of a substantially flat plate as the spacer element minimises the gap between two acoustic panels when they are connected together, thereby providing a neat and aesthetically pleasing join. The substantially flat plate is preferably rectangular and it preferably has a length of from 300 to 400 mm and preferably has a width of from 40 to 60 mm.

The spacer element preferably extends across a majority of the first minor face of the acoustic panel, more preferably across substantially all of the first minor face. This provides the spacer element with a large surface area to contact the one or more magnets of another acoustic baffle. In other words, there are more positions on the spacer element that a magnet of another acoustic baffle can be brought into contact with. As a result, it is easier to align the two acoustic baffles by adjusting the position of the magnets relative to the spacer element.

However, the spacer element may only cover a portion of the first minor face of the acoustic panel. This may reduce the materials required to manufacture the spacer element, thereby reducing the associated cost. Furthermore, reducing the size of the spacer element may reduce the weight of the acoustic baffle. It is also envisaged that a plurality of spacer elements may be fixed to the first minor face, wherein each spacer element covers a portion of said face.

It is preferred that the spacer element extends outwardly from the first minor face of the panel (e.g. perpendicular to the first minor face) by no more than 10 mm, preferably no more than 5 mm, more preferably no more than 3 mm, most preferably from 2 to 3 mm. The distance that the spacer element extends outwardly is otherwise known as the thickness of the spacer element. It is advantageous to use a thin spacer element, because this minimises the gap between two acoustic panels when they are connected together. As mentioned above, this provides a neat and aesthetically pleasing join. Furthermore, a thin spacer element minimises the weight of the acoustic baffles, thereby making installation easier.

It is preferred that the spacer element is mechanically fixed to the first minor face of the acoustic panel. In other words, the spacer element is preferably fixed to the first minor face of the acoustic panel using one or more mechanical fastening elements (e.g. screws, bolts etc.). Alternatively, the spacer element may be fixed to the first minor face with an adhesive.

For example, the first minor face of the acoustic panel and the spacer element may each be provided with one or more apertures. The spacer element may be positioned on the first minor face such that the apertures in the spacer element are aligned with the apertures in the first minor face. A screw can then be inserted through each aperture in the spacer element and into the apertures in the first minor face, thereby fixing the spacer element to the acoustic panel. A plug may be inserted into the apertures of the first minor face before the screws are inserted, in order to provide a more secure fixing. The plug comprises an external thread, which creates a thread in the aperture as the plug is inserted. This creates a secure connection between the plug and the acoustic panel. The screw can then be inserted through the aperture in the spacer element and into the plug, in order to securely fix the spacer element to the acoustic panel.

The plug can be made from any suitable material, such as plastic (e.g. polystyrene) or a metal (e.g. steel). The plastic may be glass reinforced and/or may be made from renewable materials. Suitable plugs are commercially available, such as Insulation Fixing FID 90 and Insulation Fixing FID Green 90 from Fischer, which are made from glass reinforced polystyrene. As described below, plugs may also be used to fix the magnets, the frame element, and the suspension cables to the acoustic panel. These plugs may be made from the same materials described above.

### Magnets

At least one magnet is fixed to a second minor face of the acoustic panel.

Each of the one or more magnets comprises a surface configured for contacting the spacer element fixed to the acoustic panel of another acoustic baffle. The surface is preferably substantially flat to provide optimal surface contact with the spacer element. The surface can have any suitable shape, but it is preferably approximately circular because this allows the position of the magnet relative to the spacer element to be easily adjusted in any direction.

More preferably, the at least one magnet comprises a flat surface that is in contact with the second minor face of the acoustic panel and another flat surface that contacts the spacer element of another acoustic baffle in use. This shape may minimise the gap between two acoustic panels when they are connected together, thereby providing a neat and aesthetically pleasing join.

In a particularly preferred aspect of the invention, the at least one magnet is substantially disk-shaped. The disk-shaped magnet preferably has a diameter of from 20 to 30 mm.

It is preferred that the at least one magnet extends outwardly from the second minor face of the acoustic panel (e.g. perpendicular to the second minor face) no more than 15 mm, preferably no more than 10 mm, most preferably no more than 7 mm. This distance that the magnet extends outwardly is designated the thickness. This upper limit on the thickness minimises the gap between two acoustic panels when they are connected together, thereby providing a neat and aesthetically pleasing join. Furthermore, the weight of the acoustic baffles is minimised making installation easier.

More preferably, the at least one magnet is positioned in a recess in the second minor face of the acoustic panel such that the magnet is substantially flush with the second minor face. In which case, the magnet does not substantially extend outwardly from the second minor face of the acoustic panel, thereby further reducing the gap between two acoustic panels when they are connected together.

It is preferred that the at least one magnet is positioned approximately centrally between the two major faces of the acoustic panel. In other words, the magnet is positioned approximately halfway along the width of the second minor face. This is advantageous because the size of the magnet can be increased, or the position of the magnet relative to the spacer element can be adjusted, without the magnet protruding beyond the major faces of the acoustic panels, which is not aesthetically desirable.

The at least one magnet may extend across at least half of the width of the second minor face between the two major faces of the acoustic panel. By increasing the area of the magnet, the thickness can be reduced while still providing sufficient magnetic attraction to hold the panels together. As explained above, a thinner magnet provides a more aesthetically pleasing join between two panels when they are connected together.

Any suitable number of magnets may be used. For example, two (or more) magnets may be spaced apart along the length of the second minor face of the acoustic panel.

It is preferred that the at least one magnet is mechanically fixed to the second minor face of the acoustic panel. In other words, the at least one magnet is preferably fixed to the second minor face of the acoustic panel using one or more mechanical fastening elements (e.g. screws, bolts etc.).

For example, a threaded rod may be attached to the surface of the magnet that is in contact with the second minor face of the panel. The threaded rod is inserted into an aperture provided in the second minor face of the panel, thereby fixing the magnet to the panel. A plug may be inserted into the aperture before the threaded rod is inserted, in order to provide a more secure fixing.

### Frame Element

A frame element may be attached to the third minor face of the acoustic panel. The frame element extends along at least a portion of the length of the third minor face, but preferably extends along substantially all of the length of the third minor face.

As will be discussed in more detail below, the frame element may be configured to be connected to an adjacent frame element of another acoustic baffle, which may assist with aligning the two baffles. Alternatively, a single frame element may extend along both panels to achieve the same effect.

One or more lights may be attached to the frame element to provide lighting in the room in which the acoustic baffles are suspended in use. The lights are preferably LED (light emitting diode) lights.

The LED lights may be conventional LEDs or other solid state light sources including high brightness LEDs (HBLEDs), organic LEDs (OLEDs), electroluminescent elements (EL), directly illuminating LEDs, and indirectly illuminating LEDs.

The LED lights may be low profile LEDs. The term “low profile” means that the LED light has an overall thickness, measured from the front surface (i.e. the light emitting surface) to the rear surface, that is less than 3 inches, preferably less than 2 inches, more preferably less than 1 inch.

The light and heat generated by the LED light may be emitted through the same (i.e. common) surface. A common light and heat emitting surface eliminates the need for additional heatsinking means, thereby reducing the weight of the LED light and the acoustic baffle as a whole.

The frame element can be made from any suitable material, but it is preferably made from metal. This is advantageous as it provides the frame element with sufficient rigidity and strength to support the lights attached thereto.

In a particularly preferred aspect of the invention, the frame element is a substantially U-shaped profile. In other words, the frame element has a substantially U-shaped cross section. This is advantageous as the U-shape provides the frame element with increased rigidity while keeping the weight of the frame element low.

The substantially U-shaped profile comprises a base portion (i.e. the bottom of the “U” shape) and two side portions. Preferably, the substantially U-shaped profile is attached to the acoustic panel by attaching the base portion to the third minor face of the acoustic panel such that the side portions extend away from the acoustic panel. One or more lights can be attached to the inside of the substantially U-shaped profile.

The substantially U-shaped profile can be attached to the acoustic panel by any suitable means. For example, one or more apertures may be provided in the base portion of the substantially U-shaped profile. A bolt may be inserted through each aperture in the base portion and into an aperture in the third minor face of the acoustic panel, thereby fixing the substantially U-shaped profile to the acoustic panel. A plug may be inserted into the aperture in the acoustic panel before the bolt is inserted, in order to provide a more secure fixing. Alternatively or additionally, a rod may extend through the acoustic panel and the base portion of the substantially U-shaped profile. The ends of the rod may be threaded, thereby allowing nuts to be attached. This secures the substantially U-shaped profile and the acoustic panel together.

### Suspension Cables

One or more suspension cables may be attached to the acoustic panel so that the acoustic baffle can be suspended from a ceiling in use. Any suitable suspension cables known to the skilled person may be used.

As will be discussed in more detail below, the acoustic baffle is preferably suspended such that the major faces of the acoustic panel extend downwardly. In which case, one or more suspension cables are attached to a minor face of the acoustic panel, preferably the fourth minor face. However, it may be desirable to suspend the acoustic baffles such that the major faces of the acoustic panel extend generally horizontally. In which case, one or more suspension cables may be attached to a major face of the acoustic panel.

The suspension cables may be attached to the acoustic panel in any suitable manner. For example, the suspension cable may be attached to an adapter comprising a threaded rod. The threaded rod can be inserted into an aperture in the acoustic panel to fix the suspension cable to said panel. A plug may be inserted into the aperture before the threaded rod is inserted, in order to provide a more secure fixing. In another example, the suspension cable is attached to a plate that is fixed to the acoustic panel, for example with one or more screws.

### Acoustic Baffle System

In use, acoustic baffles are suspended from a ceiling and connected together to form an “acoustic baffle system”.

As will be appreciated by the skilled person, any of the features of the acoustic panel, the spacer element, the magnets, the frame element, and the suspension cables described above may be applied to the acoustic baffle system of the invention.

In one aspect of the invention, the acoustic baffle system comprises a first acoustic panel and a second acoustic panel. A spacer element is fixed to a minor face of the first acoustic panel and at least one magnet is fixed to a minor face of the second acoustic panel. A surface of the at least one magnet is in contact with a surface of the spacer element so that the two panels are connected together. Preferably, substantially all of the surface of the at least one magnet is in contact with the surface of the spacer element.

The magnet should be strong enough to hold the two acoustic panels together. However, the magnet is preferably not so strong that it is difficult to slide the magnet along the surface of the spacer element in order to accurately align the panels. Furthermore, it may desirable to be able to easily disconnect the two acoustic panels by hand without using tools, for example to provide access to the lights fixed to the frame elements for maintenance or replacement. Once the maintenance is finished, the acoustic panels can be connected back together and accurately realigned.

In view of the above, the traction force of the magnet is preferably from 50 to 300 N, more preferably from 250 to 300 N. The traction force is defined as the load under which the magnet and a 10 mm thick ST. 37 steel plate release from each other under direct pull. In other words, the traction force is the force required to separate the magnet and the steel plate.

The traction force can be measured by any suitable apparatus that can measure the tensile force required to separate the magnet from the steel plate. The applied force should be perpendicular to the steel plate. The steel plate should be clean and sanded flat to avoid any air gaps between the plate and the magnet. Any elements connected to the magnet should not be magnetic, because these would interfere with the measurement.

The acoustic panels are each suspended from a ceiling in any desired orientation. However, the acoustic panels are preferably suspended substantially vertically. In other words, a substantially vertical axis extends through the acoustic panel, with the two major faces of the panel positioned on either side of said axis. The two major faces of the acoustic panel therefore extend downwardly, i.e. in a generally downward direction towards the floor. Preferably, the two major faces extend substantially vertically.

When the first and second acoustic panels are suspended substantially vertically, they are preferably positioned side by side. In which case, the spacer element is fixed to a minor face on a side of the first acoustic panel and the at least one magnet is fixed to a minor face on a side of the second acoustic panel, so that the spacer element and the at least one magnet are in contact. However, the acoustic panels can be suspended in any arrangement. For example, the first acoustic panel may be suspended above the second acoustic panel. In which case, the spacer element is fixed to a lower minor face of the first acoustic panel and the at least one magnet is fixed to an upper minor face of the second acoustic panel.

Alternatively, the acoustic panels could each be suspended substantially horizontally. In other words, a substantially horizontal axis extends through the acoustic panel, with the two major faces of the panel positioned on either side of said axis. The two major faces of the acoustic panel therefore extend substantially horizontally. In practice the major faces will then generally be substantially parallel to the ceiling.

When the first and second acoustic panels are suspended horizontally, they are preferably positioned side by side. In which case, the spacer element is fixed to a minor face on a side of the first acoustic panel and the at least one magnet is fixed to a minor face on a side of the second acoustic panel, so that the spacer element and the at least one magnet are in contact.

At least a portion of the ceiling that the acoustic panels are suspended from may extend at an acute angle to the floor and said portion may even extend all the way to the floor. However, the acoustic panels are preferably suspended from a ceiling that is substantially horizontal.

The acoustic panels can be suspended from the ceiling in any suitable manner. For example, the acoustic panels may be attached the grid of a suspended ceiling. However, as discussed above, the acoustic panels are typically suspended from a ceiling using one or more suspension elements, such as suspension cables.

For example, when the acoustic panels are suspended vertically, one or more suspension cables may be attached to an upper minor face of each acoustic panel. The one or more suspension cables may be attached approximately centrally between the sides of each acoustic panel.

Typically, in the prior art, when acoustic panels of the prior art are suspended substantially vertically from a ceiling, two suspension cables are attached to an upper minor face of each panel, one near each side of the panel. However, when the acoustic panels of the invention are connected together side by side, only one suspension cable may be required to support each panel. This is because the magnetic connection system of the invention allows accurate and consistent positioning of the baffles without the need for more than one suspension cable per baffle. This reduces the materials required to produce the acoustic baffle system, thereby reducing the associated cost. Preferably, the suspension cable is attached approximately centrally between the sides of each panel, so that the panels are substantially level.

However, it may not be necessary to attach suspension cables to every acoustic panel. For example, if the first acoustic panel is positioned above the second acoustic panel, suspension cables may only be attached to the first acoustic panel. In which case, the second acoustic panel is suspended by virtue of the magnetic attraction between the spacer element fixed to the first acoustic panel and the at least one magnet fixed to the second acoustic panel.

When the acoustic panels are suspended horizontally, one or more suspension cables may be attached to a major face of each acoustic panel.

In another example, at least one of the acoustic panels may be provided with a support element. The support element may extend through the acoustic panel between an upper minor face and a lower minor face of the acoustic panel. An upper end of the support element may be attached to a suspension element (such as a suspension cable) and a lower end of the support element may be attached to a frame element on the lower minor face of the acoustic panel. The suspension element can then be used to suspend the acoustic panel from a ceiling.

The support element and suspension element support the weight of the acoustic panel from below via the frame element. The load path therefore bypasses the material of the acoustic panel, which increases the overall stability of the suspended acoustic baffle system, and allows the use of larger, heavier acoustic panels. Furthermore, the frame element provides a point of attachment for additional elements (e.g. one or more lights) to be connected. The weight of these additional elements is primarily supported by the suspension element and the support element, rather than the acoustic panel itself, which avoids comprising the stability and safety of the acoustic baffle system.

The use of a support element that extends through the acoustic panel is particularly advantageous when the acoustic panel is an MMVF panel. MMVF provides the acoustic panel with good acoustic absorption properties and is chemically and thermally very stable. However, the mechanical integrity of MMVF largely depends on the binder type and content. The support element reduces the load on the acoustic panel and therefore it is not necessary for the MMVF to have a high level of mechanical integrity. This avoids the need to use a high binder content in the MMVF.

Any suitable support element may be used that can connect the suspension element to the frame element and assist in supporting the acoustic panel. For example, the support element may be a suspension cable, a rod, or a tube.

Any suitable frame element may be used to support the acoustic panel from below. For example, the frame element may simply be a washer, bracket, or plate.

Instead of using a support element, a suspension element may extend through an upper minor face of the acoustic panel to a lower minor face of the acoustic panel, wherein the suspension element is attached to a frame element on the lower minor face of the acoustic panel. This achieves the same effect of connecting the suspension element to the frame element and thereby supporting the acoustic panel from below.

Any suitable number of suspension elements may be used to suspend each acoustic panel from the ceiling. However, only a single suspension element may be required to support each acoustic panel, as discussed above. Preferably, the suspension element is positioned approximately centrally between the sides of each panel.

As mentioned above, it is preferable, for example for aesthetic reasons, that the first and second acoustic panels are suspended and connected together such that they are “aligned”. For example, this may mean that a first major face of the first acoustic panel is aligned with a first major face of the second acoustic panel. Furthermore, a second major face of the first acoustic panel may be aligned with a second major face of the second acoustic panel. When the major faces are substantially planar, the major faces are aligned when they lie in substantially the same plane.

When the acoustic panels are suspended vertically side by side, it may be preferable for an upper minor face of the first acoustic panel to be aligned with an upper minor face of the second acoustic panel. Similarly, a lower minor face of the first acoustic panel may be aligned with a lower minor face of the second acoustic panel. When the minor faces are substantially planar, they are aligned when they lie in substantially the same plane.

A frame element may be attached to a minor face of at least one of the first and second acoustic panels. The frame element extends along at least a portion of the minor face of the panel. Preferably, a frame element is attached to both of the first and second acoustic panels.

One or more lights may be attached to the frame element of one or both panels, in order to provide lighting in the room in which the acoustic panels are suspended.

In a particularly preferred aspect of the invention, a minor face of the first acoustic panel and an adjacent minor face of the second acoustic panel both have a frame element attached thereto. For example, a single frame element may extend along both panels. However, more preferably, a first frame element is attached to the first acoustic panel and a second frame element is attached to the second acoustic panel. The first and second frame elements may be connected together.

By using a single frame element that extends along both panels, or by connecting the frame elements of the panels together, the frame element(s) may assist with holding the two acoustic panels substantially in “alignment”, as discussed above.

It is preferred that each acoustic panel is provided with a separate frame element rather than providing frame elements that extend along multiple panels. This is because the frame elements can be manufactured shorter and they are therefore easier to handle and install.

When the acoustic panels are suspended vertically side by side, the minor face of the acoustic panel to which the frame element is attached is preferably a lower minor face. This is advantageous because any lights attached to the frame element can be positioned such that the light is directed downwards into the room. Furthermore, this allows a single frame element to be provided along both panels, or for the frame elements that are attached to each panel to be connected together, which may assist with aligning the panels as discussed above.

The acoustic baffle system may comprise an electrical cable, for example to power one or more lights attached to the frame elements. At least one of the first and second acoustic panels may therefore be provided with a tube for housing an electrical cable, wherein the tube extends through at least a portion of the acoustic panel. Alternatively, an aperture may simply extend through at least a portion of the acoustic panel, through which an electrical cable can be inserted.

As discussed above, the acoustic panels are preferably suspended substantially vertically and the frame element is preferably attached to a lower minor face of the panel. It is therefore preferred that the tube for housing an electrical cable extends through the panel from an upper minor face of the acoustic panel to the lower minor face to which the frame element is attached. This allows an electrical cable to extend from the ceiling, through the tube in the acoustic panel, and be connected to one or more lights attached to the frame element. Preferably, the tube extends substantially vertically.

The acoustic panels used in the acoustic baffle system preferably have the same form as the acoustic panel used in the acoustic baffle of the invention. For example, the first and second acoustic panels may each comprise a first minor face and a second minor face. The first minor face is preferably opposite to the second minor face. A spacer element is fixed to the first minor face of the first acoustic panel and at least one magnet is fixed to the second minor face of the second acoustic panel, so that the first and second acoustic panels can be connected together.

At least one magnet may be fixed to the second minor face of the first acoustic panel to enable the first acoustic panel to be connected to a further acoustic panel. Similarly, a spacer element may be fixed to the first minor face of the second acoustic panel to enable the second acoustic panel to be fixed to a further acoustic panel.

The first and second acoustic panels may each comprise a third minor face, preferably extending between opposed first and second minor faces. A frame element may be attached to the third minor face of at least one of the first and second acoustic panels, as discussed above.

The first and second acoustic panels may each comprise a fourth minor face extending between opposed first and second minor faces, wherein the fourth minor face is opposite to the third minor face. One or more suspension cables may be attached to the fourth minor face of each acoustic panel to suspend the panels from the ceiling, as discussed above.

The acoustic panels are therefore preferably suspended such that the first and second minor faces are on the sides of the panels, the third minor face is the lower minor face, and the fourth minor face is the upper minor face.

In another aspect of the invention, the acoustic baffle system comprises: an acoustic panel comprising two opposed major faces and a plurality of minor faces that extend between the two major faces, wherein the acoustic panel is suspended from a ceiling by a suspension element; and a support element extending through the acoustic panel between an upper minor face and a lower minor face of the acoustic panel, wherein an upper end of the support element is attached to the suspension element and a lower end of the support element is attached to a frame element on the lower minor face of the acoustic panel.

In another aspect of the invention, the acoustic baffle system comprises: an acoustic panel comprising two opposed major faces and a plurality of minor faces that extend between the two major faces, wherein the acoustic panel is suspended from a ceiling by a suspension element, wherein the suspension element extends through an upper minor face of the acoustic panel to a lower minor face of the acoustic panel, and wherein the suspension element is attached to a frame element on the lower minor face of the acoustic panel.

As discussed above, connecting the suspension element to the frame element (either directly or via the support element) supports the acoustic panel from below and increases the stability and safety of the acoustic baffle system.

The acoustic baffle system in which the acoustic panel is supported from below via the frame element may be used in combination with any other features described above.

### Method of Installing Acoustic Baffle System

The present invention also provides a method of installing an acoustic baffle system, the method comprising:
(i) providing a first acoustic panel and a second acoustic panel, wherein each acoustic panel comprises two opposed major faces and one or more minor faces that extend between the two major faces;
(ii) fixing a spacer element to a minor face of the first acoustic panel, wherein the spacer element comprises a ferromagnetic material;
(iii) fixing at least one magnet to a minor face of the second acoustic panel;
(iv) suspending the first and second acoustic panels from a ceiling; and
(v) bringing a surface of the at least one magnet into contact with a surface of the spacer element to connect the first and second acoustic panels together.

As will be appreciated by the skilled person, any of the features of the acoustic panel, the spacer element, the magnets, the frame element, and the suspension cables described above may be applied to the method of the invention.

Steps (ii) to (v) may be performed in any suitable order. For example the spacer element and the at least one magnet may be fixed to the acoustic panels after they have been suspended from the ceiling. However, it is easier to fix the spacer element and the at least one magnet to the acoustic panels before the panels are suspended from the ceiling. Therefore, it is preferred that steps (ii) and (iii) are performed before step (iv).

As discussed above, the acoustic panels may be suspended in any desired orientation and arrangement. However, the acoustic panels are preferably suspended substantially vertically such that the two major faces of each panel extend downwardly. Furthermore, the panels are preferably positioned side by side and therefore the spacer element is fixed to a minor face on a side of the first acoustic panel and the at least one magnet is fixed to a minor face on a side of the second acoustic panel.

After the first and second acoustic panels are connected together, the position of the at least one magnet relative to the spacer element may be adjusted in order to align the two panels.

For example, when the acoustic panels are suspended vertically side by side, the method of the invention may comprise:
(vi) adjusting the position of the at least one magnet relative to the spacer element such that an upper minor face of the first acoustic panel is aligned with an upper minor face of the second acoustic panel and/or such that a lower minor face of the first acoustic panel is aligned with a lower minor face of the second acoustic panel.

The method may also comprise:
(vii) adjusting the position of the at least one magnet relative to the spacer element so that a major face of the first acoustic panel is aligned with a major face of the second acoustic panel.

Adjusting the position of the at least one magnet relative to the spacer element may comprise sliding the magnet along the surface of the spacer element.

The method may further comprise:
(viii) attaching a frame element to a minor face of at least one of the first and second acoustic panels, wherein the frame element extends along at least a portion of the minor face.

Step (viii) may further comprise attaching one or more lights to the frame elements, such that the acoustic baffle system provides lighting in the room in which it is installed.

As explained above, it is preferred that a frame element is attached to both acoustic panels. For example, step (viii) may comprise attaching a single frame element such that it extends along both panels. More preferably, step (viii) comprises attaching a first frame element to the first acoustic panel and attaching a second frame element to the second acoustic panel. Step (viii) may further comprise connecting the first and second frame elements together.

Alternatively, the frame elements may be pre-attached to the acoustic panels when they are provided in step (i). For example, step (i) may comprise providing the first and second acoustic panels with a first frame element attached to a minor face of the first acoustic panel and a second frame element attached to a minor face of the second acoustic panel. In which case, step (viii) may only comprise connecting the first and second frame elements together.

As explained above, when the acoustic panels are suspended vertically side by side, the frame element is preferably attached to a lower minor face of each acoustic panel.

As will be appreciated by the skilled person, steps (vi), (vii), and (vii) may be performed at any suitable time during the method of the invention.

In a particularly preferable method of the invention, step (viii) is performed before step (iv). This is advantageous because it is easier to attach the frame elements and lights before the acoustic panels are suspended from a ceiling. Furthermore, attaching the frame elements first may mean that the panels are already substantially aligned before they are suspended from the ceiling, in particular in the case where a single frame element extends across more than one acoustic panel. As a result, only minor adjustments may therefore be necessary once the panels are suspended, in order to perfectly align the panels as desired. Step (vi) and/or step (vii) is therefore preferably performed after step (iv).

### Kit for Installing Acoustic Baffle System

The present invention may be provided in the form of a kit for installing an acoustic baffle system.

The kit of the invention comprises:
(i) a first acoustic panel and a second acoustic panel, wherein each acoustic panel comprises two opposed major faces and one or more minor faces that extend between the two major faces;
(ii) a spacer element configured to be attached to a minor face of the first acoustic panel, wherein the spacer element comprises a ferromagnetic material;
(iii) at least one magnet configured to be attached to a minor face of the second acoustic panel; and
(iv) one or more suspension elements for suspending the acoustic panels from a ceiling.

The suspension elements may be any elements that can be used to suspend the acoustic panels from a ceiling. Preferably, the suspension elements are suspension cables. However, the suspension elements may instead be rigid rods or clips that can be used to attach the acoustic panels to a suspended ceiling grid.

As will be appreciated by the skilled person, any of the features of the acoustic panel, the spacer element, the magnets, the frame element, and the suspension cables described above may be applied to the kit of the invention.

The kit may further comprise instructions for installing the acoustic baffle system.

### BRIEF DESCRIPTION OF DRAWINGS

FIGS. 1a and 1b depict exploded views of an example of an acoustic baffle according to the invention.

FIG. 1c is an enlarged view of the spacer element depicted in FIG. 1a.

FIG. 1d is an enlarged view of one of the magnets depicted in FIG. 1b.

FIG. 1e depicts the acoustic baffle shown in FIG. 1a, with a suspension cable attached.

FIG. 1f is an enlarged view of the suspension cable depicted in FIG. 1e.

FIG. 2a depicts an exploded view showing the components of an example of an acoustic baffle system according to the invention before the acoustic panels have been suspended and connected together.

FIG. 2b depicts the acoustic baffle system shown in FIG. 2a after the acoustic panels have been connected together.

FIG. 2c depicts the acoustic baffle system shown in FIG. 2b, but with a frame element attached to each acoustic panel.

FIGS. 2d and 2e depict the interface of the acoustic panels shown in FIG. 2c, before the acoustic panels are connected together.

FIGS. 2f and 2g depict exploded views of the acoustic panels shown in FIG. 2c.

FIG. 2h depicts a side view of the first acoustic panel shown in FIG. 2c.

### DETAILED DESCRIPTION

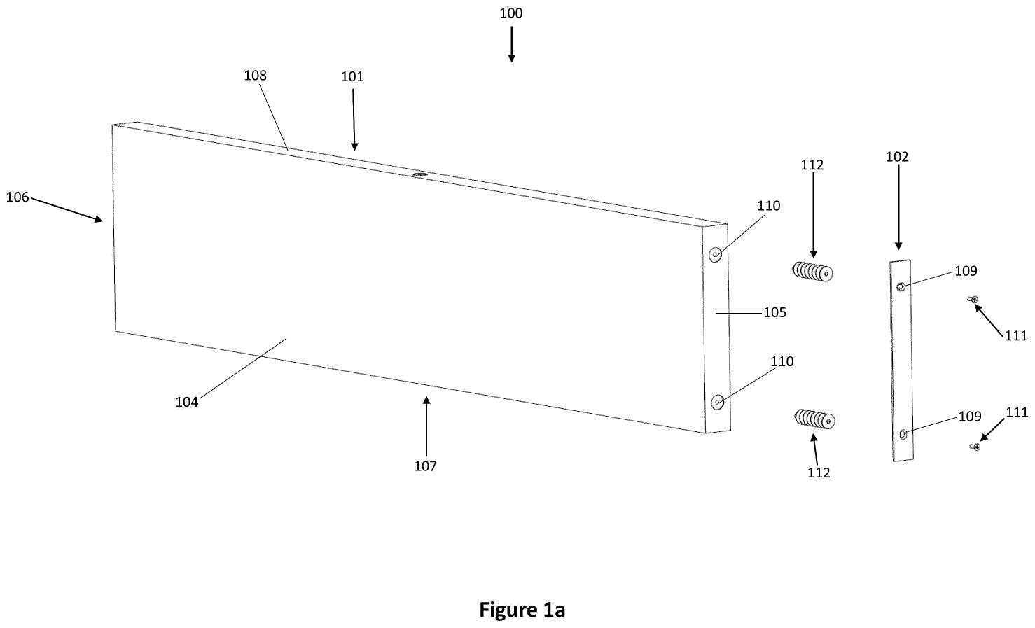

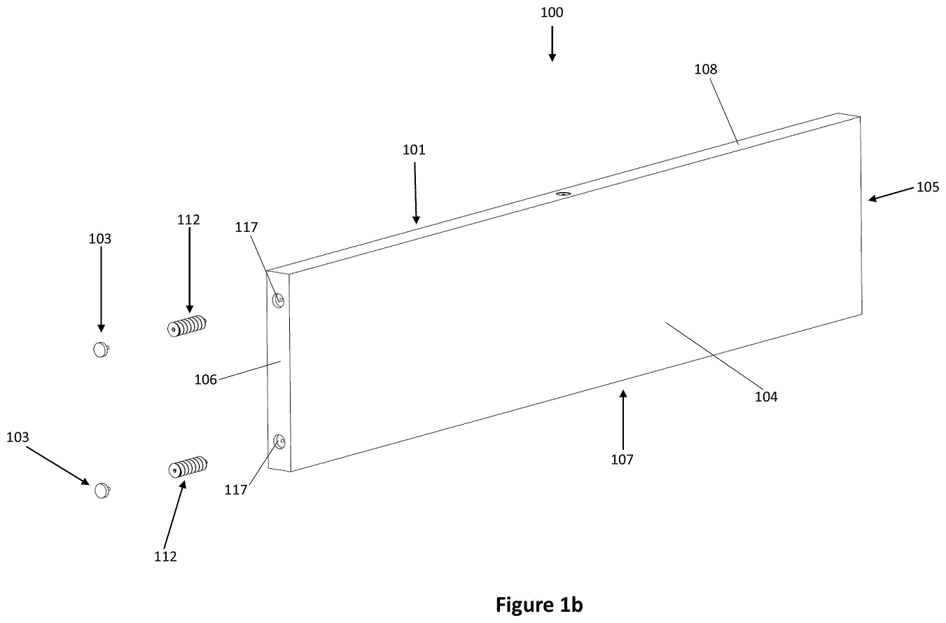

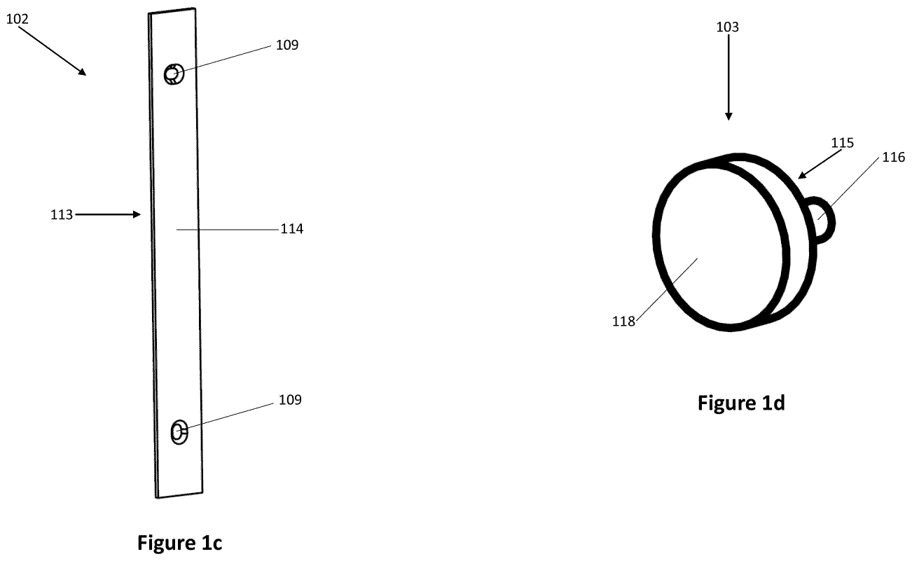

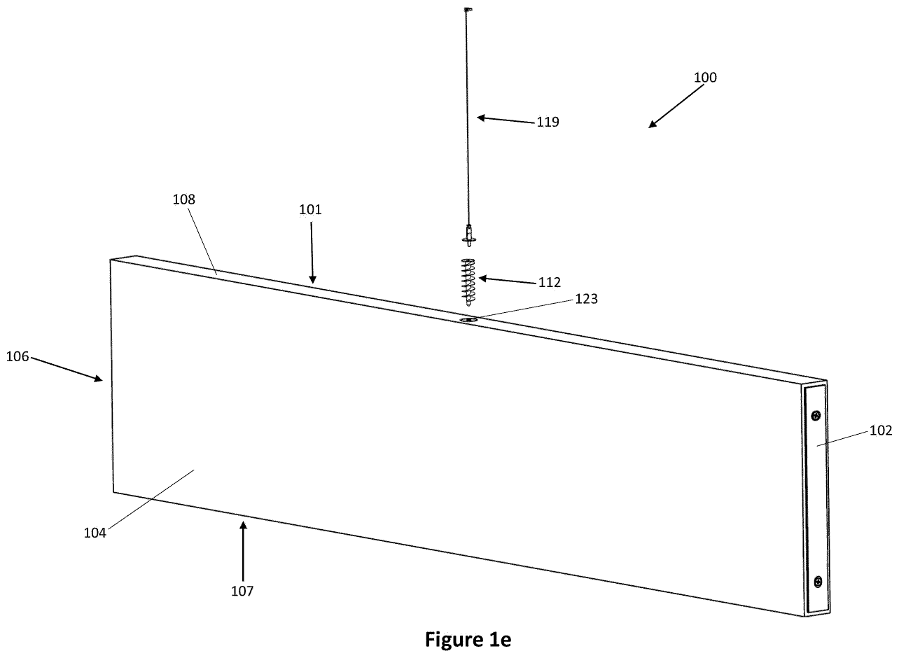

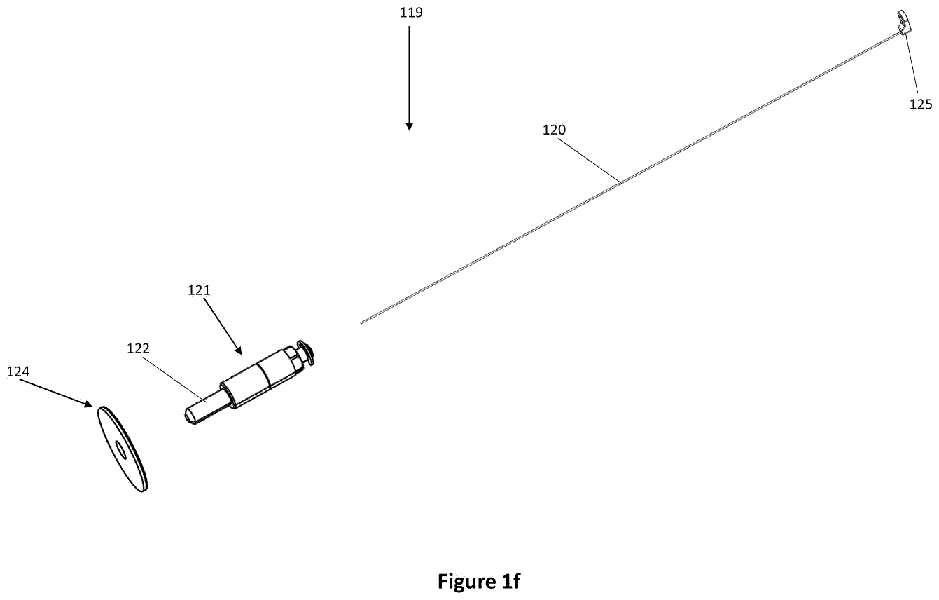

FIGS. 1a and 1b depict exploded views of an example of the acoustic baffle 100 of the invention. FIGS. 1a and 1b show different side views of the same acoustic baffle 100.

The acoustic baffle 100 comprises an acoustic panel 101, a spacer element 102, and magnets 103.

Any suitable acoustic panel 101 may be used, but the acoustic panel 101 depicted in FIGS. 1a and 1b comprises two opposed major faces 104, a first minor face 105, a second minor face 106, a third minor face 107, and a fourth minor face 108. The first minor face 105 is opposite to the second minor face 106 and the third minor face 107 extends between the opposed first and second minor faces 105, 106. Similarly, the fourth minor face 108 extends between the opposed first and second minor faces 105, 106 and is opposite to the third minor face 107. The two major faces 104 and the minor faces 105, 106, 107, 108 are all substantially planar. Furthermore, the two major faces 104 are substantially rectangular and the minor faces 105, 106, 107, 108 extend substantially perpendicular to the two major faces 104.

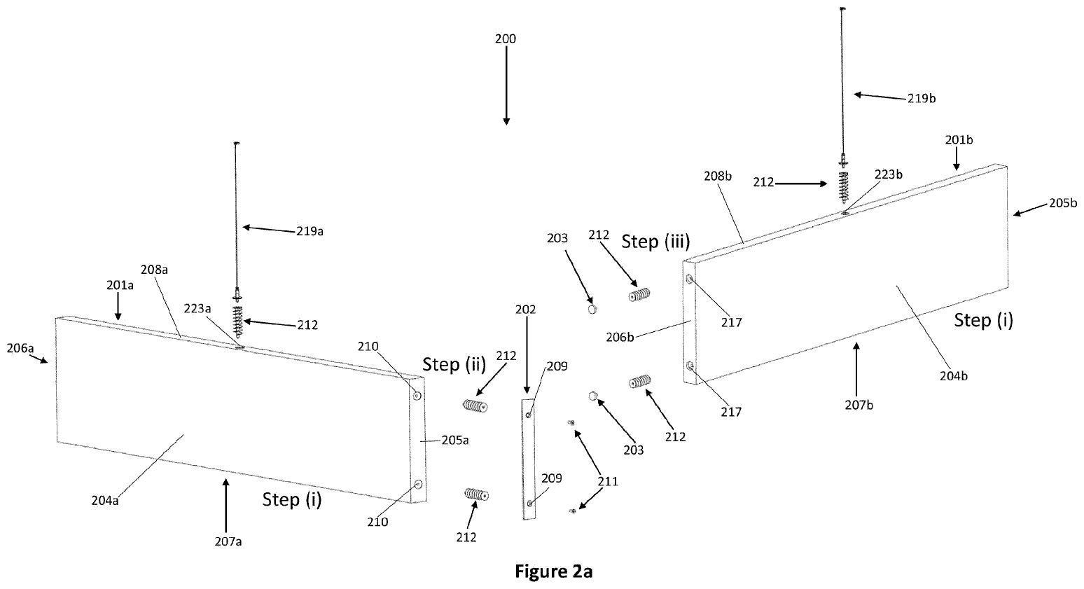

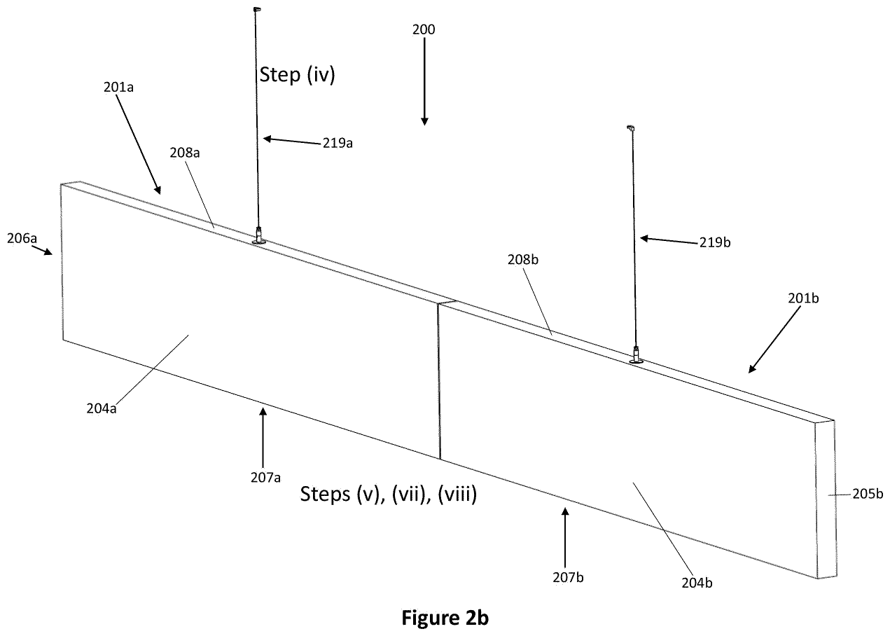

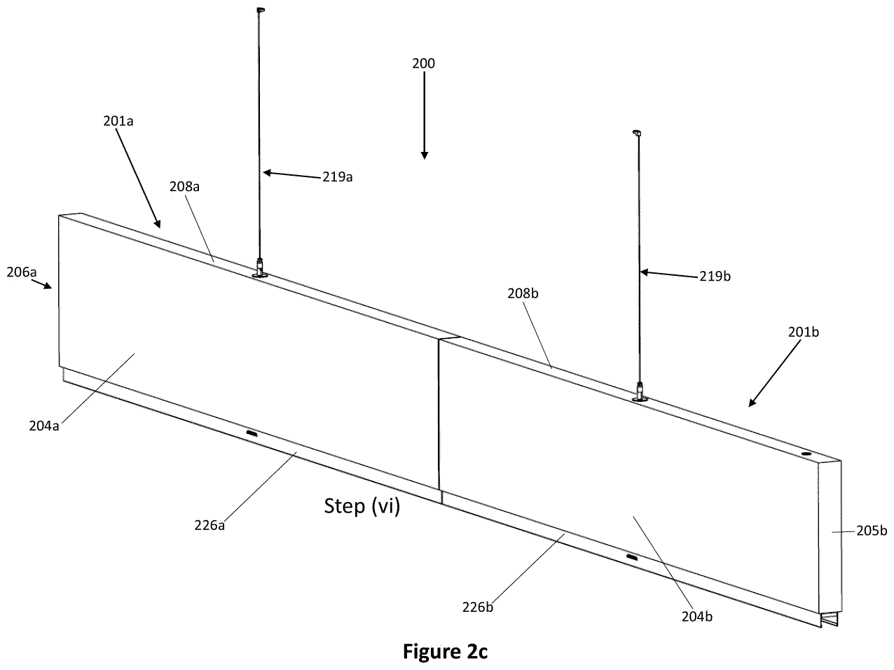

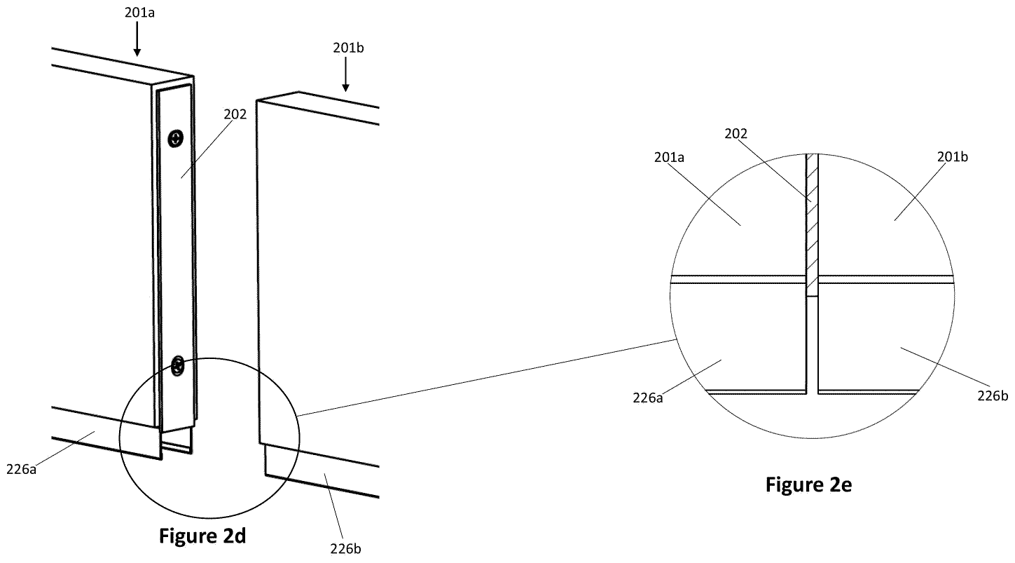

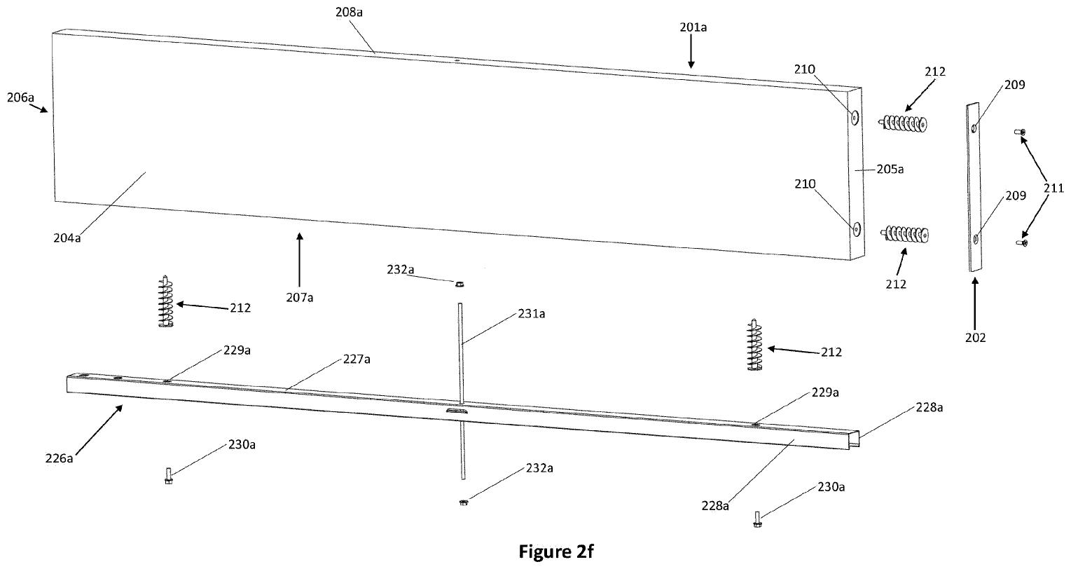

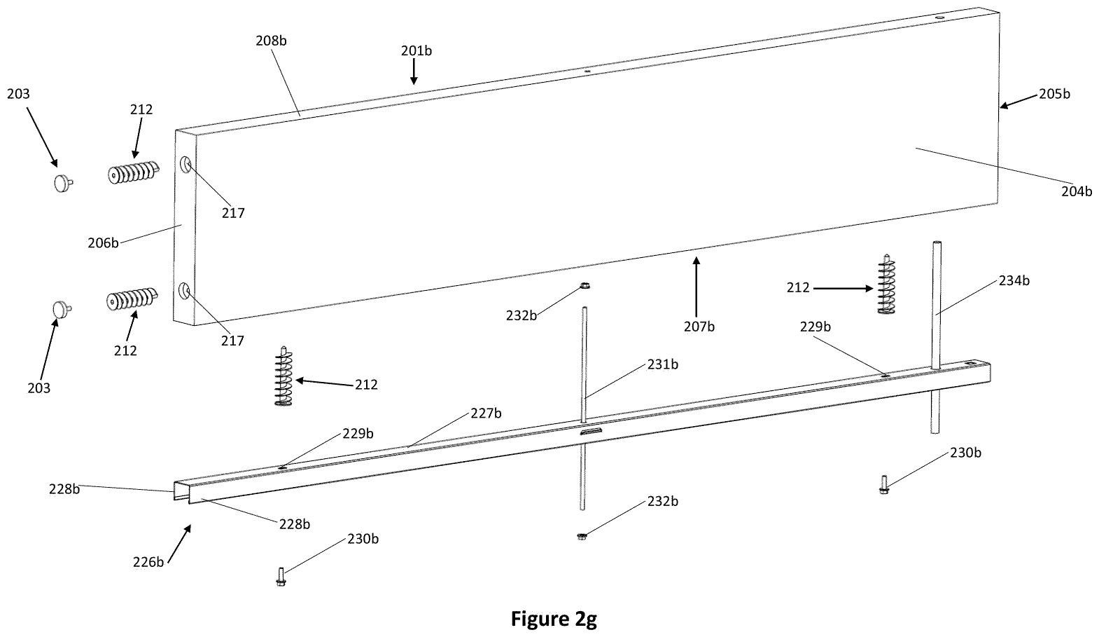

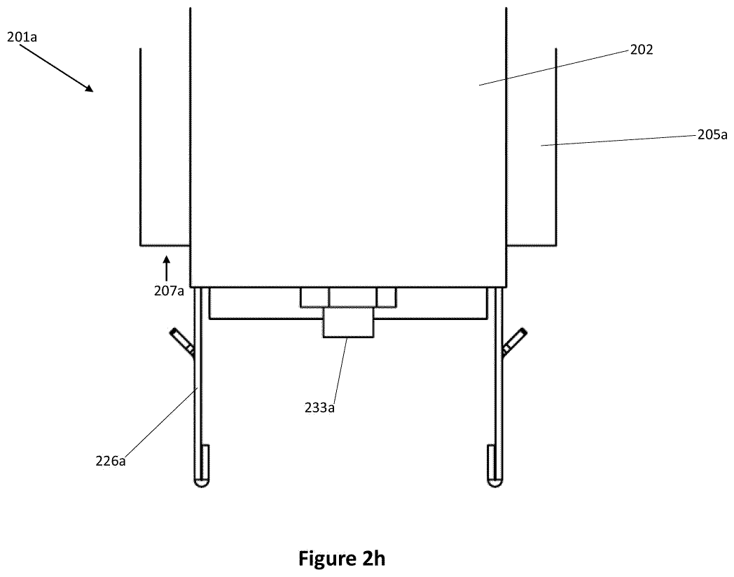

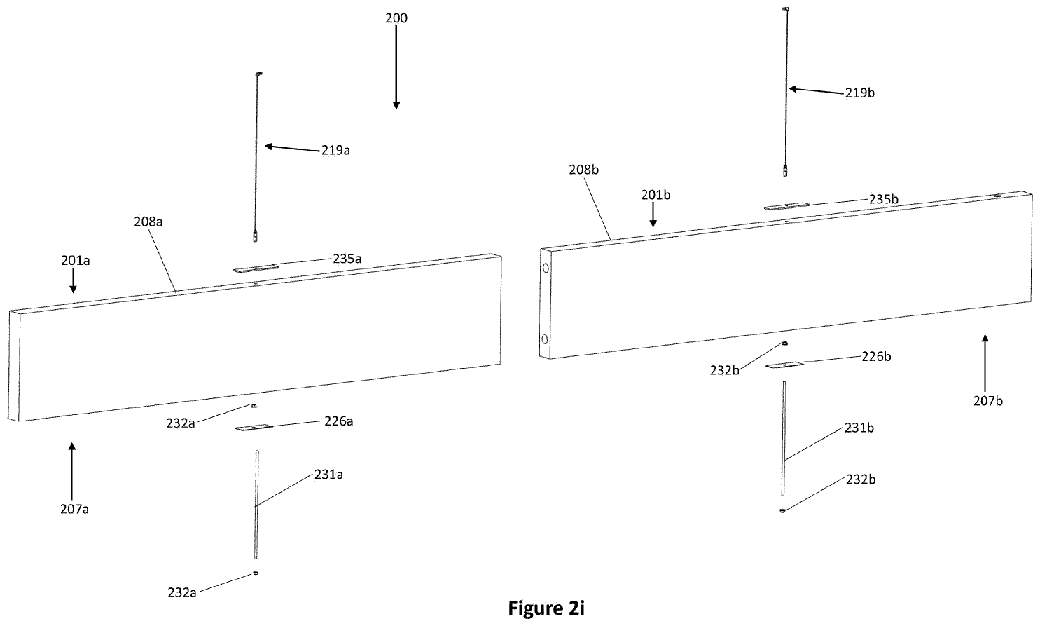

As depicted in FIG. 1a, the spacer element 102 is fixed to the first minor face 105 of the acoustic panel 101. As depicted in FIG. 1b, the magnets 103 are fixed to the second minor face 106 of the acoustic panel 101. The spacer element 102 comprises a ferromagnetic material, i.e. a material that is attracted to magnets 103. It is therefore possible to connect the acoustic baffle 100 depicted in FIGS. 1a and 1b to another such acoustic baffle 100 by bringing the magnets 103 of one acoustic baffle 100 into contact with the spacer element 102 of another acoustic baffle 100. The magnetic attraction between the magnets 103 and the spacer element 102 holds the acoustic baffles 100 together. The connection of two acoustic panels in this manner is shown in FIG. 2b, for example.

Any suitable ferromagnetic material can be used. For example, the spacer element 102 may be made from galvanised steel. However, the spacer element 102 could, for example, primarily be made from plastic as long as sufficient ferromagnetic material (e.g. galvanised steel) is included such that the magnetic attraction is strong enough to hold the acoustic baffles 100 together.

As mentioned above, the first minor face 105 of the acoustic panel 101 in FIGS. 1a and 1b is opposite to the second minor face 106. A plurality of acoustic baffles 100 can therefore be connected together in a row. However, the first and second minor faces 105, 106 may be positioned anywhere on the acoustic panel 101 to achieve any desired arrangement of the acoustic baffles 100.

Any suitable spacer element 102 may be used, but the spacer element 102 depicted in FIG. 1a is formed from a substantially flat plate. An enlarged view of the spacer element 102 is shown in FIG. 1c. The spacer element 102 is provided with two apertures 109 and the first minor face 105 of the acoustic panel 101 is also provided with two apertures 110. A screw 111 can therefore be inserted through each aperture 109 in the spacer element 102 and into an aperture 110 in the first minor face 105 of the acoustic panel 101, thereby fixing the spacer element 102 to the acoustic panel 101. A plug 112 (for example made of plastic) may be inserted into the aperture 110 in the acoustic panel 101 before the screw 111 is inserted, in order to provide a more secure fixing. The plug 112 comprises an external thread, which creates a thread in the aperture 110 when the plug 112 is inserted. This creates a secure connection between the plug 112 and the acoustic panel 101. The screw 111 can then be screwed into the plug 112 to fix the spacer element 102 to the acoustic panel 101.

As shown in FIGS. 1a and 1c, the spacer element 102 has a first substantially flat surface 113 that contacts the first minor face 105 of the acoustic panel 101 and a second substantially flat surface 114 that will contact the magnets 103 of another acoustic baffle 100 during installation. By forming the spacer element 102 from a substantially flat plate, the “thickness” of the spacer element 102 can be minimised. This reduces the gap between two acoustic panels 101 when they are connected together, thereby providing a neat and aesthetically pleasing join.

Since the first minor face 105 of the acoustic panel 101 in FIG. 1a is substantially rectangular, it is advantageous for the spacer element 102 to also be substantially rectangular, as shown in FIGS. 1a and 1c. This allows the spacer element 102 to cover substantially all of the first minor face 105 of the acoustic panel 101. As a result, there are more positions on the spacer element 102 that the magnets 103 of another acoustic baffle 100 can be brought into contact with, which makes it easier to connect the two acoustic baffles 100 so that they are aligned.

As will be appreciated by the skilled person, more than one spacer element 102 may be fixed to the first minor face 105 of the acoustic panel 101. For example, the acoustic baffle 100 depicted in FIGS. 1a and 1b comprises two magnets 103 fixed to the second minor face 106. Therefore, two separate spacer elements 102 could be fixed to the first minor face 105 of the acoustic panel 101, with one spacer element 102 positioned opposite to each magnet 103. When two acoustic baffles 100 are connected together, one magnet 103 would therefore be in contact with one of the spacer elements 102 and the other magnet 103 would be in contact with the other spacer element 102. By using two smaller spacer elements 102 (compared to one large spacer element 102), the materials required to produce the spacer elements 102 can be reduced, thereby reducing the associated cost.

Any suitable magnets 103 may be used, but the magnets 103 depicted in FIG. 1b are substantially disk-shaped. An enlarged view of one of the magnets 103 is depicted in FIG. 1d. The magnet 103 has a first substantially flat surface 115, from which a threaded rod 116 protrudes (the thread cannot be seen in FIG. 1d). The threaded rod 116 can be inserted into an aperture 117 provided in the second minor face 106 of the acoustic panel 101, thereby fixing the magnet 103 to the acoustic panel 101. A plug 112 may be inserted into the aperture 117 before the threaded rod 116 of the magnet 103 is inserted, in order to provide a more secure fixing.

The magnet 103 further comprises a second substantially flat surface 118 that will contact the spacer element 102 of another acoustic baffle 100 during installation. Again, the use of a substantially flat magnet 103 minimises the gap between two acoustic panels 101 when they are connected together, thereby providing a neat and aesthetically pleasing join.

A recess may be provided around each aperture 117 in the second minor face 106 of the acoustic panel 101, as shown in FIG. 1b. This allows the magnet 103 to be positioned inside the recess and therefore the surface 118 of the magnet is substantially flush with the second minor face 106 of the acoustic panel 101. This further minimises the gap between two acoustic panel 101 when they are connected together. In FIG. 1b, the recess around the apertures 117 is substantially circular to accommodate the disk-shaped magnets. However, the recess can have any suitable shape to accommodate a magnet 103 having any shape.

In FIG. 1b, two magnets 103 are spaced apart along the length of the second minor face 106 of the acoustic panel 101, but any suitable number of magnets 103 may be used. For example, it may be necessary to use more than two magnets 103 when the acoustic baffle 100 is heavier (e.g. if a heavy frame element and lights are attached to the acoustic panel 101) in order to hold the acoustic baffles 100 together in alignment. Similarly, in certain embodiments only one magnet 103 may be required. For example, if a frame element is attached to the bottom of the acoustic panel 101 as will be discussed in more detail below, this may force the acoustic baffles 100 substantially into alignment. Therefore, only a single magnet 103 may be required to accurately align the baffles 100.

During installation, the acoustic baffle 100 is suspended from a ceiling (not shown), for example by one or more suspension cables 119 as depicted in FIG. 1e. In this example, a suspension cable 119 is attached to the fourth minor face 108 of the acoustic panel 101. When the suspension cable 119 is attached to a ceiling, the acoustic panel 101 is therefore suspended substantially vertically. As a result, the two major faces 104 of the acoustic panel 101 extend substantially vertically. The fourth minor face 108 is therefore an upper minor face, the third minor face 107 is a lower minor face, and the first and second minor faces 105, 106 are on the sides of the acoustic panel 101.

FIG. 1f is an enlarged exploded view showing the components of the suspension cable 119. The suspension cable 119 comprise a rope 120, for example made of steel. One end of the rope 120 is attached to an adapter 121 comprising a threaded rod 122 (the thread is not shown in FIG. 1d). The threaded rod 122 can be inserted into an aperture 123 in the fourth minor face 108 of the acoustic panel 101 to fix the suspension cable 119 to the acoustic panel 101. A plug 112 may be inserted into the aperture 123 before the threaded rod 122 is inserted, in order to provide a more secure fixing. A washer 124 may be provided around the aperture 123 to protect the surface of the acoustic panel 101. The other end of the rope 120 is attached to drawbar eye 125 which can be attached to a ceiling.

While the figures show the acoustic baffle 100 suspended using a suspension cable 119, other means for suspending the acoustic baffle 100 from a ceiling can be used. For example, the acoustic baffle 100 may be attached to the grid of the suspended ceiling.

FIG. 2a depicts an exploded view showing the components of an example of the acoustic baffle system 200 of the invention, before the acoustic panels 201a, 201b are suspended from a ceiling and connected together.

The acoustic baffle system 200 comprises a first acoustic panel 201a and a second acoustic panel 201b. In FIG. 2a, the acoustic panels 201a, 201b are substantially the same as the acoustic panel 101 depicted in FIGS. 1a and 1b. A spacer element 202 is fixed to the first minor face 205a of the first acoustic panel 201a and magnets 203 are fixed to the second minor face 206b of the second acoustic panel 201b, to allow the acoustic panels 201a, 201b to be connected together. It is not necessary to fix one or more magnets 203 to the first acoustic panel 201a or to fix a spacer element to the second acoustic panel 201b, but this may be desirable in order to connect further acoustic panels.

FIG. 2b shows the acoustic baffle system 200 shown in FIG. 2a, once the acoustic panels 201a, 201b have been suspended and connected together. In the example depicted in FIG. 2b, the acoustic panels are suspended substantially vertically and positioned side by side.

Various steps in the method of the invention for installing the acoustic baffle system are also labelled in FIGS. 2a and 2b. Step (i) comprises providing the first and second acoustic panels 201a, 201b. Step (ii) comprises fixing the spacer element 202 to the first minor face 205a of the first acoustic panel 201a. Step (iii) comprises fixing the magnets 203 to the second minor face 206b of the second acoustic panel 201b. Step (iv) comprises suspending the acoustic panels 201a, 201b from a ceiling (not shown). Step (v) comprises bringing the magnets 203 into contact with the spacer element 202 to connect the two acoustic panels 201a, 201b together. As discussed above, these steps may be performed in any suitable order.

For aesthetic reasons, the acoustic panels 201a, 201b are preferably connected together in such that they are substantially “aligned”, as depicted in FIG. 2b. In other words, the corresponding major faces 204a, 204b of the acoustic panels 201a, 201b lie in substantially the same plane. Furthermore, the fourth minor face 208a (the upper minor face) of the first acoustic panel 201a lies in substantially the same plane as the fourth minor face 208b (the upper minor face) of the second acoustic panel 201b. Similarly, the third minor face 207a (the lower minor face) of the first acoustic panel 201a lies in substantially the same plane as the third minor face 207b (the lower minor face) of the second acoustic panel 201b.

When the acoustic panels 201a, 201b are first connected together, they may not be accurately aligned as shown in FIG. 2b. However, the present invention allows for easy adjustment of the relative positions of the acoustic panels 201a, 201b to ensure they are accurately aligned. For example, it may be possible to slide the magnets 203 along the surface of the spacer element 202 while they are in contact with each other, thereby adjusting the relative positions of the acoustic panels 201a, 201b.

More specifically, when the acoustic panels 201a, 201b are first connected together, the corresponding major faces 204 of the panels 201a, 201b may not be accurately aligned. In which case, the magnets 203 may each need to be moved to the left or to the right relative to the spacer element 202 in order to bring the major faces 204a of the panels 201a, 201b into alignment. Similarly, when the acoustic panels 201a, 201b are first connected together, the top and bottom of the acoustic panels 201a, 201b may not be accurately aligned (particularly if a frame element 226a, 226b is not attached to the panels as discussed below). In which case, the magnets 203 may need to be moved upwards or downwards relative to the spacer element 202 in order to bring the top and bottom of the acoustic panels 201a, 201b into alignment. Adjusting the position of the magnets 203 relative to the spacer element 202 in order to align the panels 201a, 201b is step (vi) and step (vii) in the method of the invention.

An advantage of the invention is that only a single suspension cable 219a, 219b may be required to support each acoustic panel 201a, 20ab, as shown in FIGS. 2a and 2b. This is because the magnetic connection system allows accurate and consistent positioning of the acoustic panels 201a, 201b without the need for more than one suspension cable 219a, 219b per acoustic panel 201a, 201b. The single suspension cable 219a, 219b is preferably attached approximately centrally between the sides of each acoustic panel 201a, 201b, so that the panels 201a, 201b are suspended substantially level. In other words, the suspension cable 219a, 219b is attached approximately halfway along the length of the fourth minor face 208a, 208b of each acoustic panel 201a, 201b.

A frame element 226a, 226b may be attached to at least one of the acoustic panels 201a, 201b, as depicted in FIG. 2c. In this example, a first frame element 226a is attached to the third minor face 207a (the lower minor face) of the first acoustic panel 201a and a second frame element 226b is attached to the third minor face 207b (the lower minor face) of the second acoustic panel 201b. Each frame element 226a, 226b extends along at least a portion of the third minor face 207a, 207b of the acoustic panel 201a, 201b to which it is attached. However, it is preferred that each frame element 226a, 226b extends along substantially all of the length of the third minor face 207a, 207b of the acoustic panel 201a, 201b to which it is attached, as shown in FIG. 2c. Attaching the frame element 226a, 226b is step (viii) in the method of the invention. Alternatively, the frame elements 226a, 226b may be pre-attached to the acoustic panels 201a, 201b when they are provided.

The first frame element 226a may be connected to the second frame element 226b. This may force the acoustic panels 201a, 201b substantially into alignment. Only minor adjustments of the position of the magnets 203 relative to the spacer element 202 may therefore be required in order to accurately align the acoustic panels 201a, 201b. Alternatively, a single frame element 226 may be provided across both acoustic panels 201a, 201b to achieve the same effect.

The frame elements 226a, 226b may be connected together in any suitable manner. For example, the spacer element 202 may extend below the third minor face 207a (the lower minor face) of the first acoustic panel 201a, as shown in FIG. 2d. When the first and second acoustic panels 201a, 201b are connected together, the spacer element 202 is therefore sandwiched between the frame elements 226a, 226b. This is shown in FIG. 2e, which is a close up of the interface between the frame elements 226a, 226b. If the frame elements 226a, 226b are made from a ferromagnetic material, they will be attracted to the spacer element 202 and thereby connected together.

In the acoustic baffle system 200 depicted in the figures, the frame elements 226a, 226b are substantially U-shaped profiles. This is advantageous as it provides the frame elements 226a, 226b with higher rigidity and strength.

FIGS. 2f and 2g show exploded views of the first and second acoustic panels 201a, 201b depicted in FIG. 2c. The suspension cables 219a, 219b have been omitted for simplicity.

As can be seen in FIGS. 2f and 2g, the substantially U-shaped profile 226a, 226b comprises a base portion 227a, 227b (i.e. the bottom of the U shape) and side portions 228a, 228b. The base portion 227a, 227b is attached to the third minor face 207a, 207b of the acoustic panel 201a, 201b such that the side portions 228a, 228b extend away from the acoustic panel 201a, 201b.

Apertures 229a, 229b are provided in the base portion 227a, 227b of the substantially U-shaped profile 226a, 226b. Bolts 230a, 230b can be inserted through the apertures 229a, 229b in the base portion 227a, 227b and into apertures (not shown) in the third minor face 207a, 207b (the lower minor face) of the acoustic panel 201a, 210b. Plugs 212 may be inserted into the apertures before the bolts 230a, 230b are inserted, in order to provide a more secure fixing. Further, a threaded rod 231a, 231b is provided through the base portion 227a, 227b of the substantially U-shaped profile 226a, 226b and the acoustic panel 201a, 201b. Nuts 232a, 232b are provided at the ends of the threaded rod 231a, 231b. The substantially U-shaped profile 226a, 226b is thereby fixed to the acoustic panel 201a, 201b.

One or more lights 233a, 233b may be attached to at least one of the frame elements 226a, 226b in order to provide lighting in the room in which the acoustic baffle system 200 is installed. FIG. 2h shows a side view of the first acoustic panel 201a depicted in FIGS. 2c and 2f. A LED light 233a can be seen attached to the underside of the first substantially U-shaped profile 226a. The light 233a is positioned such that light will be directed downwards into the room in which the acoustic baffle system 200 is installed. A series of lights 233a may be provided spaced apart along the length of the first substantially U-shaped profile 226a. While it cannot be seen in the figures, one or more lights 233b may be attached to the second substantially U-shaped profile 226b attached to the second acoustic panel 201b in the same manner.

It may be necessary for the acoustic baffle system 200 to comprise an electrical cable, for example to power the lights 233a, 233b attached to the frame elements 226a, 226b. At least one of the acoustic panels 201a, 201b may therefore be provided with a tube 234 for housing an electrical cable.

In FIG. 2g, a tube 234b extends substantially vertically from the fourth minor face 208b (upper minor face) of the second acoustic panel 201b to the second substantially U-shaped profile 226b. An electrical cable can therefore be inserted through the tube 234b and be connected to the lights 233b attached to the second substantially U-shaped profile 226b.

In FIGS. 2f and 2g, a suspension cable 219a, 219b (not shown) may be attached to the upper end of each threaded rod 231a, 231b extending through the acoustic panels 201a, 201b. For example, the suspension cable 219a, 219b may have an internal thread that allows it to be screwed onto the threaded rod 231a, 231b. In this manner, the suspension cable 219a, 219b is connected to the frame element 226a, 226b via the threaded rod 231a, 231b and thereby supports the acoustic panel 201a, 201b from underneath. The load path therefore bypasses the material of the acoustic panel 201a, 201b, which increase the overall stability of the suspended acoustic baffle system 200. Furthermore, the weight of any additional elements attached to the frame element 226a, 226b, such as LED lights 233a, 233b, is primarily supported by the suspension cable 219a, 219b rather than the acoustic panel 201a, 201b. The threaded rods 231a, 231b thereby function as support elements, which are described in more detail above.

However, it is not necessary for the frame element 226a, 226b to be a substantially U-shaped profile. Any suitable frame element 226a, 226b may be used. For example, FIG. 2i depicts an exploded view of an alternative embodiment in which the spacer elements 226a, 226b are plates/washers (the magnets 203 and spacer element 202 have been omitted from FIG. 2i for simplicity). A threaded rod 231a, 231b extends through each acoustic panel 201a, 201b between the upper minor face 208a, 208b and the lower minor face 207a, 207b of the acoustic panel 201a, 201b, in the same manner as shown in FIGS. 2f and 2g. The upper end of the threaded rod 231a, 231b is attached to the suspension cable 219a, 219b and the lower end of the threaded rod 231a, 231b is attached to the frame element 226a, 226b.

The upper end of the threaded rod 231a, 231b may pass through a hole in a plate/washer 235a, 235b before connecting to the suspension cable 219a, 219b. This prevents the suspension cable 219a, 219 penetrating into the acoustic panel 201a, 201b as it is screwed onto the threaded rod 231a, 231b.

While threaded rods 231a, 231b are used as the support elements in the embodiments depicted in the figures, any suitable support elements may be used.

### Numbered Embodiments

Embodiment 1. An acoustic baffle comprising:
an acoustic panel comprising two opposed major faces and a plurality of minor faces that extend between the two major faces;
a spacer element fixed to a first minor face of the acoustic panel, wherein the spacer element comprises a ferromagnetic material; and
at least one magnet fixed to a second minor face of the acoustic panel.

Embodiment 2. An acoustic baffle according to embodiment 1, wherein the acoustic panel further comprises a third minor face.

Embodiment 3. An acoustic baffle according to embodiment 2, further comprising a frame element attached to a third minor face of the acoustic panel, wherein the frame element extends along at least a portion of the length of the third minor face.

Embodiment 4. An acoustic baffle according to embodiment 3, wherein the frame element is a substantially U-shaped profile.

Embodiment 5. An acoustic baffle according to embodiment 3 or 4, wherein the frame element is made of metal.

Embodiment 6. An acoustic baffle according to any of embodiments 3 to 5, further comprising one or more lights attached to the frame element, preferably wherein the lights are LED lights.

Embodiment 7. An acoustic baffle according to any of embodiments 2 to 6, wherein the second minor face is opposite the first minor face and the third minor face extends between the first and second minor faces.

Embodiment 8. An acoustic baffle according to embodiment 7, wherein the acoustic panel further comprises a fourth minor face extending between the first and second minor faces, wherein the fourth minor face is opposite the third minor face.

Embodiment 9. An acoustic baffle according to embodiment 8, wherein the two major faces of the acoustic panel are substantially rectangular and the minor faces extend substantially perpendicular to the two major faces.

Embodiment 10. An acoustic baffle according to embodiment 9, wherein the lengths of the first and second minor faces are shorter than the lengths of the third and fourth minor faces.

Embodiment 11. An acoustic baffle according to any preceding embodiment, wherein the acoustic panel is a man-made vitreous fibre (MMVF) panel.

Embodiment 12. An acoustic baffle according to any of embodiments 7 to 11, wherein the at least one magnet is fixed to the second minor face such that it is opposite to the spacer element fixed to the first minor face.

Embodiment 13. An acoustic baffle according to any preceding embodiment, wherein the spacer element comprises a substantially flat surface configured for contacting at least one magnet of another acoustic baffle, preferably wherein the spacer element is a substantially flat plate.

Embodiment 14. An acoustic baffle according to any preceding embodiment, wherein the spacer element extends across a majority of the first minor face of the acoustic panel, preferably wherein the spacer element extends across substantially all of the first minor face.

Embodiment 15. An acoustic baffle according to any preceding embodiment, wherein the spacer element extends outwardly from the first minor face of the acoustic panel by no more than 10 mm, preferably no more than 5 mm, more preferably no more than 3 mm, most preferably from 2 to 3 mm.

Embodiment 16. An acoustic baffle according to any preceding embodiment, wherein the at least one magnet comprises a substantially flat surface configured for contacting a spacer element of another acoustic baffle, preferably wherein the surface is approximately circular, most preferably wherein the at least one magnet is substantially disk-shaped.

Embodiment 17.An acoustic baffle according to any preceding embodiment, wherein the at least one magnet is positioned approximately centrally between the two major faces of the acoustic panel.

Embodiment 18. An acoustic baffle according to any preceding embodiment, wherein the at least one magnet extends across at least half of the width of the second minor face between the two major faces of the acoustic panel.

Embodiment 19. An acoustic baffle according to any preceding embodiment, wherein the at least one magnet extends outwardly from the second minor face of the acoustic panel no more than 15 mm, preferably no more than 10 mm, most preferably no more than 7 mm.

Embodiment 20. An acoustic baffle according to any preceding embodiment, wherein the at least one magnet is positioned in a recess in the second minor face of the acoustic panel such that the magnet is substantially flush with the second minor face.

Embodiment 21. An acoustic baffle according to any preceding embodiment, comprising two magnets spaced apart along the length of the second minor face of the acoustic panel.

Embodiment 22. An acoustic baffle according to any preceding embodiment, wherein the spacer element and/or the at least one magnet are mechanically fastened to the acoustic panel.

Embodiment 23. An acoustic baffle system comprising:
a first acoustic panel and a second acoustic panel, wherein each acoustic panel comprises two opposed major faces and one or more minor faces that extend between the two major faces, and wherein each acoustic panel is suspended from a ceiling;
a spacer element fixed to a minor face of the first acoustic panel, wherein the spacer element comprises a ferromagnetic material; and
at least one magnet fixed to a minor face of the second acoustic panel;
wherein a surface of the at least one magnet is in contact with a surface of the spacer element, thereby connecting the first and second acoustic panels together.

Embodiment 24. An acoustic baffle system according to embodiment 23, wherein substantially all of the surface of the at least one magnet is in contact with the surface of the spacer element.

Embodiment 25. An acoustic baffle system according to embodiment 23 or 24, wherein the traction force of the at least one magnet is from 50 to 300 N, preferably from 250 to 300 N.

Embodiment 26. An acoustic baffle system according to any of embodiments 23 to 25, wherein the acoustic panels are suspended such that the two major faces of each panel extend downwardly.

Embodiment 27. An acoustic baffle system according to embodiment 26, wherein the spacer element is fixed to a minor face on a side of the first acoustic panel and the at least one magnet is fixed to a minor face on a side of the second acoustic panel.

Embodiment 28. An acoustic baffle system according to embodiment 27, wherein each acoustic panel is suspended from the ceiling by one or more suspension cables attached to an upper minor face of each acoustic panel.

Embodiment 29. An acoustic baffle system according to embodiment 28, wherein each acoustic panel is suspended from the ceiling by only one suspension cable, preferably wherein the suspension cable is attached approximately centrally between the sides of each panel.

Embodiment 30. An acoustic baffle system according to any of embodiments 27 to 29, wherein a frame element is attached to a lower minor face of at least one of the first and second acoustic panels, wherein the frame element extends along at least a portion of the lower minor face.

Embodiment 31. An acoustic baffle system according to embodiment 30, wherein a single frame element extends along both panels.

Embodiment 32. An acoustic baffle system according to embodiment 30, wherein a first frame element is attached to the first acoustic panel and a second frame element is attached to the second acoustic panel, optionally wherein the first and second frame elements are connected together.

Embodiment 33. An acoustic baffle system according to any of embodiments 23 to 32, wherein at least one of the first and second acoustic panels comprises a tube for housing an electrical cable, wherein the tube extends through at least a portion of the acoustic panel.

Embodiment 34. A method of installing an acoustic baffle system, the method comprising:
(i) providing a first acoustic panel and a second acoustic panel, wherein each acoustic panel comprises two opposed major faces and one or more minor faces that extend between the two major faces;
(ii) fixing a spacer element to a minor face of the first acoustic panel, wherein the spacer element comprises a ferromagnetic material;
(iii) fixing at least one magnet to a minor face of the second acoustic panel;
(iv) suspending the first and second acoustic panels from a ceiling; and
(v) bringing a surface of the at least one magnet into contact with a surface of the spacer element to connect the first and second acoustic panels together.

Embodiment 35. An acoustic baffle system according to embodiment 34, wherein the acoustic panels are suspended such that the two major faces of each panel extend downwardly.

Embodiment 36. An acoustic baffle system according to embodiment 35, wherein the acoustic panels are suspended such that the minor face to which the spacer element is fixed is on a side of the first acoustic panel and the minor face to which the at least one magnet is fixed is on a side of the second acoustic panel.

Embodiment 37. A method according to embodiment 36, further comprising:
(vi) adjusting the position of the at least one magnet relative to the spacer element such that an upper minor face of the first acoustic panel is aligned with an upper minor face of the second acoustic panel and/or such that a lower minor face of the first acoustic panel is aligned with a lower minor face of the second acoustic panel.

Embodiment 38. A method according to any of embodiments 34 to 37, further comprising:
(vii) adjusting the position of the at least one magnet relative to the spacer element so that a major face of the first acoustic panel is aligned with a major face of the second acoustic panel.

Embodiment 39. A method according to embodiment 37 or 38, wherein the position of the at least one magnet relative to the spacer element is adjusted after the acoustic panels have been suspended from the ceiling.

Embodiment 40. A method according to any of embodiments 36 to 39, further comprising:
(vi) attaching a frame element to a lower minor face of at least one of the first and second acoustic panels, wherein the frame element extends along at least a portion of the lower minor face.

Embodiment 41. A method according to embodiment 40, wherein step (vi) comprises attaching a single frame element such that it extends along both panels.

Embodiment 42. A method according to embodiment 40, wherein step (vi) comprises attaching a first frame element to the first acoustic panel, attaching a second frame element to the second acoustic panel, and optionally connecting the first and second frame elements together.

Embodiment 43. A method according to any of embodiments 40 to 42, wherein step (vi) further comprises attaching one or more lights to the frame elements, preferably wherein the frame elements and lights are attached before the acoustic panels are suspended from the ceiling.

Embodiment 44. A kit for installing an acoustic baffle system, the kit comprising:
a first acoustic panel and a second acoustic panel, wherein each acoustic panel comprises two opposed major faces and one or more minor faces that extend between the two major faces;
a spacer element configured to be attached to a minor face of the first acoustic panel, wherein the spacer element comprises a ferromagnetic material;
at least one magnet configured to be attached to a minor face of the second acoustic panel; and
one or more suspension elements for suspending the acoustic panels from a ceiling.

1. An acoustic baffle comprising:
an acoustic panel comprising two opposed major faces and a plurality of minor faces that extend between the two major faces, wherein the acoustic panel is a man-made vitreous fibre (MMVF) panel;
a spacer element fixed to a first minor face of the acoustic panel, wherein the spacer element comprises a ferromagnetic material; and
at least one magnet fixed to a second minor face of the acoustic panel.

2. An acoustic baffle according to claim 1, wherein the acoustic panel further comprises a third minor face.

3. An acoustic baffle according to claim 2, further comprising a frame element attached to a third minor face of the acoustic panel, wherein the frame element extends along at least a portion of the length of the third minor face, preferably wherein the frame element is a substantially U-shaped profile.

4. An acoustic baffle according to claim 3, wherein the frame element is made of metal; and/or
wherein the acoustic baffle further comprises one or more lights attached to the frame element, preferably wherein the lights are LED lights.

5. An acoustic baffle according to claim 2, wherein the second minor face is opposite the first minor face and the third minor face extends between the first and second minor faces.

6. An acoustic baffle according to claim 1, wherein the spacer element comprises a substantially flat surface configured for contacting at least one magnet of another acoustic baffle, preferably wherein the spacer element is a substantially flat plate; and/or
wherein the spacer element extends across a majority of the first minor face of the acoustic panel, preferably wherein the spacer element extends across substantially all of the first minor face; and/or
wherein the spacer element extends outwardly from the first minor face of the acoustic panel by no more than 10 mm, preferably no more than 5 mm, more preferably no more than 3 mm, most preferably from 2 to 3 mm.

7. An acoustic baffle according to claim 1, wherein the at least one magnet comprises a substantially flat surface configured for contacting a spacer element of another acoustic baffle, preferably wherein the surface is approximately circular, most preferably wherein the at least one magnet is substantially disk-shaped; and/or
wherein the at least one magnet is positioned approximately centrally between the two major faces of the acoustic panel; and/or
wherein the at least one magnet extends across at least half of the width of the second minor face between the two major faces of the acoustic panel; and/or
wherein the at least one magnet is positioned in a recess in the second minor face of the acoustic panel such that the magnet is substantially flush with the second minor face.

8. An acoustic baffle system comprising:
a first acoustic panel and a second acoustic panel, wherein each acoustic panel comprises two opposed major faces and one or more minor faces that extend between the two major faces, wherein each acoustic panel is a man-made vitreous fibre (MMVF) panel, and wherein each acoustic panel is suspended from a ceiling;
a spacer element fixed to a minor face of the first acoustic panel, wherein the spacer element comprises a ferromagnetic material; and
at least one magnet fixed to a minor face of the second acoustic panel;
wherein a surface of the at least one magnet is in contact with a surface of the spacer element, thereby connecting the first and second acoustic panels together.

9. An acoustic baffle system according to claim 8, wherein substantially all of the surface of the at least one magnet is in contact with the surface of the spacer element; and/or
wherein the traction force of the at least one magnet is from 50 to 300 N, preferably from 250 to 300 N.

10. An acoustic baffle system according to claim 8, wherein the acoustic panels are suspended such that the two major faces of each panel extend downwardly.

11. An acoustic baffle system according to claim 10, wherein the spacer element is fixed to a minor face on a side of the first acoustic panel and the at least one magnet is fixed to a minor face on a side of the second acoustic panel.

12. An acoustic baffle system according to claim 11, wherein each acoustic panel is suspended from the ceiling by one or more suspension cables attached to an upper minor face of each acoustic panel, preferably wherein each acoustic panel is suspended from the ceiling by only one suspension cable, more preferably wherein the suspension cable is attached approximately centrally between the sides of each panel.

13. An acoustic baffle system according to claim 11, wherein a frame element is attached to a lower minor face of at least one of the first and second acoustic panels, wherein the frame element extends along at least a portion of the lower minor face.

14. An acoustic baffle system according to claim 13, wherein a single frame element extends along both panels; or
wherein a first frame element is attached to the first acoustic panel and a second frame element is attached to the second acoustic panel.

15. An acoustic baffle system according to claim 11, wherein at least one of the acoustic panels is suspended from a ceiling by a suspension element, wherein a support element extends through the acoustic panel between an upper minor face and a lower minor face of the acoustic panel, wherein an upper end of the support element is attached to the suspension element and a lower end of the support element is attached to a frame element on the lower minor face of the acoustic panel.

16. A method of installing an acoustic baffle system, the method comprising:
(i) providing a first acoustic panel and a second acoustic panel, wherein each acoustic panel comprises two opposed major faces and one or more minor faces that extend between the two major faces, and wherein each acoustic panel is a man-made vitreous fibre (MMVF) panel;
(ii) fixing a spacer element to a minor face of the first acoustic panel, wherein the spacer element comprises a ferromagnetic material;
(iii) fixing at least one magnet to a minor face of the second acoustic panel;
(iv) suspending the first and second acoustic panels from a ceiling; and
(v) bringing a surface of the at least one magnet into contact with a surface of the spacer element to connect the first and second acoustic panels together.

17. An acoustic baffle system according to claim 16, wherein the acoustic panels are suspended such that the two major faces of each panel extend downwardly.

18. An acoustic baffle system according to claim 17, wherein the acoustic panels are suspended such that the minor face to which the spacer element is fixed is on a side of the first acoustic panel and the minor face to which the at least one magnet is fixed is on a side of the second acoustic panel.

19. A method according to claim 18, further comprising:
(vi) adjusting the position of the at least one magnet relative to the spacer element such that an upper minor face of the first acoustic panel is aligned with an upper minor face of the second acoustic panel and/or such that a lower minor face of the first acoustic panel is aligned with a lower minor face of the second acoustic panel; and/or
wherein the method further comprises:
(vii) adjusting the position of the at least one magnet relative to the spacer element so that a major face of the first acoustic panel is aligned with a major face of the second acoustic panel.

20. A kit for installing an acoustic baffle system, the kit comprising:
a first acoustic panel and a second acoustic panel, wherein each acoustic panel comprises two opposed major faces and one or more minor faces that extend between the two major faces, and wherein each acoustic panel is a man-made vitreous fibre (MMVF) panel;
a spacer element configured to be attached to a minor face of the first acoustic panel, wherein the spacer element comprises a ferromagnetic material;
at least one magnet configured to be attached to a minor face of the second acoustic panel; and
one or more suspension elements for suspending the acoustic panels from a ceiling.
